(19) United States
(12) Patent Application Publication
(10) Pub. No.: US 2017/0223760 A1
(43) Pub. Date: Aug. 3, 2017

(54) USER TERMINAL AND BASE STATION

(71) Applicant: KYOCERA CORPORATION, Kyoto (JP)

(72) Inventors: Hiroyuki ADACHI, Kawasaki-shi, Kanagawa (JP); Masato FUJISHIRO, Yokohama-shi, Kanagawa (JP); Chiharu YAMAZAKI, Ota-ku, Tokyo (JP); Yushi NAGASAKA, Yokohama-shi, Kanagawa (JP); Kugo MORITA, Yokohama-shi, Kanagawa (JP)

(73) Assignee: KYOCERA CORPORATION, Kyoto (JP)

(21) Appl. No.: 15/501,181

(22) PCT Filed: Aug. 5, 2015
(86) PCT No.: PCT/JP2015/072243

§ 371 Date: Feb. 2, 2017

Related U.S. Application Data
(60) Provisional application No. 62/034,640, filed on Aug. 7, 2014.

(51) Int. Cl. H04W 76/02; H04W 48/12; H04W 48/16; H04W 84/02; H04L 29/08; H04W 92/18; H04W 88/08; H04W 4/00; H04W 36/38

(52) U.S. Cl. CPC H04W 76/023; H04W 4/005; H04W 48/12; H04W 48/16; H04W 36/38; H04W 4/008; H04L 29/08306; H04W 92/18; H04W 88/08; H04W 84/02; H04W 8/005

(57) ABSTRACT

A user terminal according to an embodiment is a user terminal configured to exist in a first cell in a mobile communication system that supports a D2D proximity service between the user terminal configured to exist in the first cell and a user terminal configured to exist in a second cell. The user terminal comprises: a controller configured to measure a timing difference between a timing of a signal received from the first cell and a timing of a signal received from the second cell; and a transmitter configured to notify a base station configured to manage the first cell, of the timing difference.

### TECHNICAL FIELD

The present application relates to a user terminal and a bases station used in a mobile communication system that supports D2D proximity service.

### BACKGROUND ART

In 3GPP (3rd Generation Partnership Project) which is a project aiming to standardize a mobile communication system, the introduction of a Device to Device (D2D) proximity service is discussed as a new function in Release 12 and later (see Non Patent Document 1).

The D2D proximity service is a service in which direct Device-to-Device communication is provided. The D2D proximity service includes a discovery procedure (Discovery) in which a proximal terminal is discovered and D2D communication (Communication) that is direct Device-to-Device communication.

A discovery procedure in which a user terminal that exists in a first cell discovers a proximal terminal that exists in a second cell provided around the first cell is called an inter-cell discovery procedure (Inter-Cell Discovery). D2D communication in which a user terminal that exists in the first cell performs communication with the proximal terminal that exists in the second cell is called inter-cell D2D communication (Inter-Cell Communication).

In the D2D proximity service, a radio resource used in the discover procedure or the D2D communication (hereinafter, “resource pool”) is designated from a network side. However, in an environment where no synchronization is established between the first cell and the second cell, it is not possible to appropriately perform the inter-cell discovery procedure or the inter-cell D2D communication. For example, even when a user terminal that exists in the first cell attempts to perform the inter-cell discovery procedure or the inter-cell D2D communication by using the resource pool designated by the first cell, a proximal terminal that exists in the second cell is not capable of receiving a signal transmitted from the user terminal that exists in the first cell because no synchronization is established between the first cell and the second cell.

### PRIOR ART DOCUMENT

### Non-Patent Document

Non Patent Document 1: 3GPP technical report “TR 36.843 V12.0.1” March, 2014

### SUMMARY OF THE INVENTION

A first aspect is summarized as a user terminal configured to exist in a first cell in a mobile communication system that supports a D2D proximity service between the user terminal configured to exist in the first cell and a user terminal configured to exist in a second cell, comprising: a controller configured to measure a timing difference between a timing of a signal received from the first cell and a timing of a signal received from the second cell; and a transmitter configured to notify a base station configured to manage the first cell, of the timing difference.

A second aspect is summarized as a base station configured to manage a first cell in a mobile communication system that supports a D2D proximity service between a user terminal configured to exist in the first cell and a user terminal configured to exist in a second cell, comprising: a receiver configured to receive, from a plurality of user terminals configured to exist in the first cell, a timing difference between a timing of a signal received from the first cell and a timing of a signal received from the second cell; a controller configured to determine, on the basis of the timing difference received from the plurality of user terminals configured to exist in the first cell, a single timing difference used in the D2D proximity service; and a transmitter configured to notify the plurality of user terminals configured to exist in the first cell, of the single timing difference.

A third aspect is summarized as a base station configured to manage a first cell in a mobile communication system that supports a D2D proximity service between a user terminal configured to exist in the first cell and a user terminal configured to exist in a second cell, comprising: a receiver configured to receive, from a base station configured to manage the second cell, timing information indicating a timing of a signal transmitted from the second cell; and a controller configured to determine, on the basis of the timing information, a timing difference used in the D2D proximity service.

### BRIEF DESCRIPTION OF THE DRAWINGS

FIG. 1 is a configuration diagram of an LTE system according to a first embodiment.

FIG. 2 is a block diagram of a UE 100 according to the first embodiment.

FIG. 3 is a block diagram of an eNB 200 according to the first embodiment.

FIG. 4 is a protocol stack diagram of a radio interface according to the first embodiment.

FIG. 5 is a configuration diagram of a radio frame used in the LTE system according to the first embodiment.

FIG. 6 is a diagram showing an operation environment according to the first embodiment.

FIG. 7 is a sequence diagram showing an operation according to the first embodiment.

FIG. 8 is a sequence diagram showing an operation according to the first embodiment.

FIG. 9 is a sequence diagram showing an operation according to the first embodiment.

FIG. 10 is a sequence diagram showing an operation according to a first modification.

FIG. 11 is a diagram showing an example of the deployment scenario for inter-frequency.

### DESCRIPTION OF THE EMBODIMENT

Hereinafter, a communication method, a user terminal, and a base station according to an embodiment will be described with reference to the accompanying drawings. It is noted that, in the description of the drawings below, like or identical portions are referred to by like reference numerals or symbols.

It will be appreciated that the drawings are schematically shown and the ratio and the like of each dimension are different from the real ones. Accordingly, specific dimensions, etc. should be determined in consideration of the explanation below. Of course, among the drawings, the dimensional relationship and the ratio may be different.

[Overview of Embodiment]

A user terminal according to an embodiment is a user terminal configured to exist in a first cell in a mobile communication system that supports a D2D proximity service between the user terminal configured to exist in the first cell and a user terminal configured to exist in a second cell. The user terminal comprises: a controller configured to measure a timing difference between a timing of a signal received from the first cell and a timing of a signal received from the second cell; and a transmitter configured to notify a base station configured to manage the first cell, of the timing difference.

A base station according to an embodiment is a base station configured to manage a first cell in a mobile communication system that supports a D2D proximity service between a user terminal configured to exist in the first cell and a user terminal configured to exist in a second cell. The base station comprises: a receiver configured to receive, from a plurality of user terminals configured to exist in the first cell, a timing difference between a timing of a signal received from the first cell and a timing of a signal received from the second cell; a controller configured to determine, on the basis of the timing difference received from the plurality of user terminals configured to exist in the first cell, a single timing difference used in the D2D proximity service; and a transmitter configured to notify the plurality of user terminals configured to exist in the first cell, of the single timing difference.

Thus, in an embodiment, from a user terminal that exists in the first cell to a base station that manages the first cell, a timing difference between a timing of a signal received from the first cell and a timing of a signal received from the second cell is notified. As a result, even in an environment where no synchronization is established between the first cell and the second cell, it is possible to perform a D2D proximity service between a user terminal that exists in the first cell and a user terminal that exists in the second cell.

A base station according to an embodiment is a base station configured to manage a first cell in a mobile communication system that supports a D2D proximity service between a user terminal configured to exist in the first cell and a user terminal configured to exist in a second cell. The base station comprises: a receiver configured to receive, from a base station configured to manage the second cell, timing information indicating a timing of a signal transmitted from the second cell; and a controller configured to determine, on the basis of the timing information, a timing difference used in the D2D proximity service.

Thus, in an embodiment, the base station that manages the first cell determines, on the basis of a plurality of timing differences notified from a plurality of user terminals that exists in the first cell, a single timing difference used for a D2D proximity service, and notifies the plurality of user terminals that exists in the first cell of a single timing difference. Thus, it is possible to determine a single timing difference acceptable by many user terminals that exist in the first cell. Further, even in an environment where no synchronization is established between the first cell and the second cell, it is possible to perform a D2D proximity service between a user terminal that exists in the first cell and a user terminal that exists in the second cell.

It is noted that in an embodiment, the first cell and the second cell may be an Inter-Cell having a coverage different from each other, may be an Inter-Frequency-Cell operated by a frequency different from each other, and may be an Inter-PLMN-Cell that belongs to a PLMN (Public Land Mobile Network) different from each other.

### First Embodiment

Hereinafter, the present embodiment will be described by using an LTE system based on 3GPP standard as an example of a mobile communication system.

(1) System Configuration

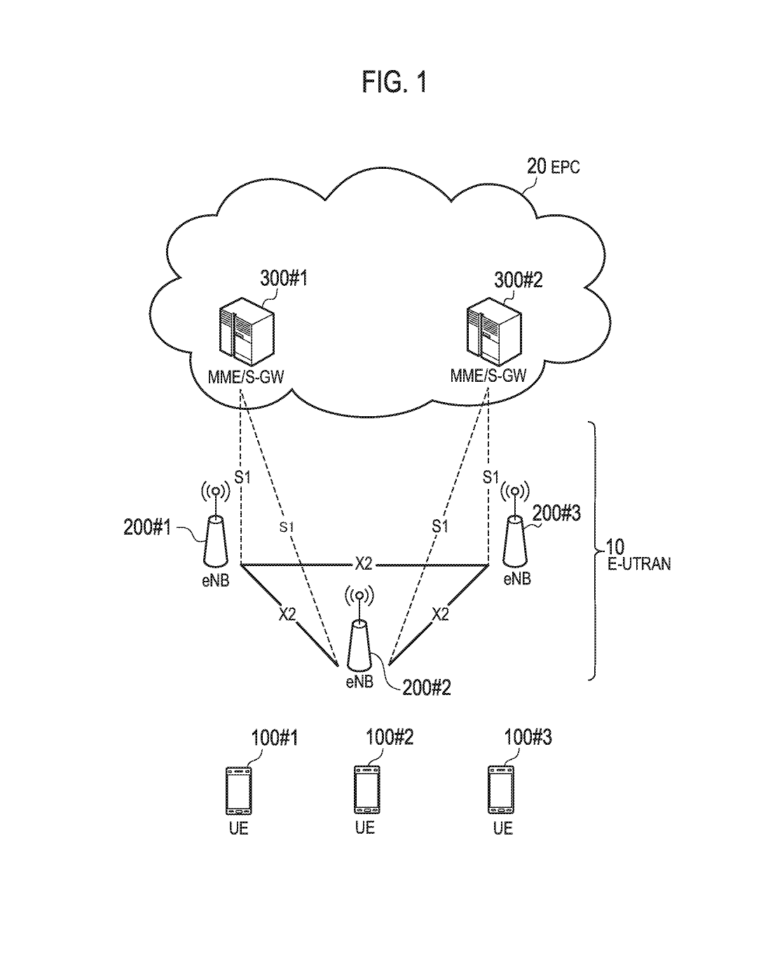

A system configuration of the LTE system according to the first embodiment will be described. FIG. 1 is a configuration diagram of an LTE system according to the present embodiment.

As shown in FIG. 1, the LTE system according to the first embodiment includes UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell in a case where the UE 100 is in a RRC connected state) with which a connection is established. Configuration of the UE 100 will be described below.

The E-UTRAN 10 corresponds to a radio access network. The E-UTRAN 10 includes eNBs 200 (evolved Node-Bs). The eNB 200 corresponds to a base station. The eNBs 200 are connected mutually via an X2 interface. Configuration of the eNB 200 will be described below.

The eNB 200 forms a cell or a plurality of cells and performs radio communication with the UE 100 that establishes a connection with the cell. The eNB 200, for example, has a radio resource management (RRM) function, a function of routing user data, and a measurement control function for mobility control and scheduling. The “cell” is used as a term indicating a minimum unit of a radio communication area, and is also used as a term indicating a function of performing radio communication with the UE 100.

The EPC 20 corresponds to a core network. The EPC 20 includes MME (Mobility Management Entity)/S-GW (Serving-Gateway) 300. The MME is a network node that performs various mobility controls and the like, for the UE 100. The S-GW is a network node that performs control to transfer user data. The MME/S-GW 300 is connected to the eNB 200 via an S1 interface. It is noted that the E-UTRAN 10 and the EPC 20 constitute a network of the LTE system.

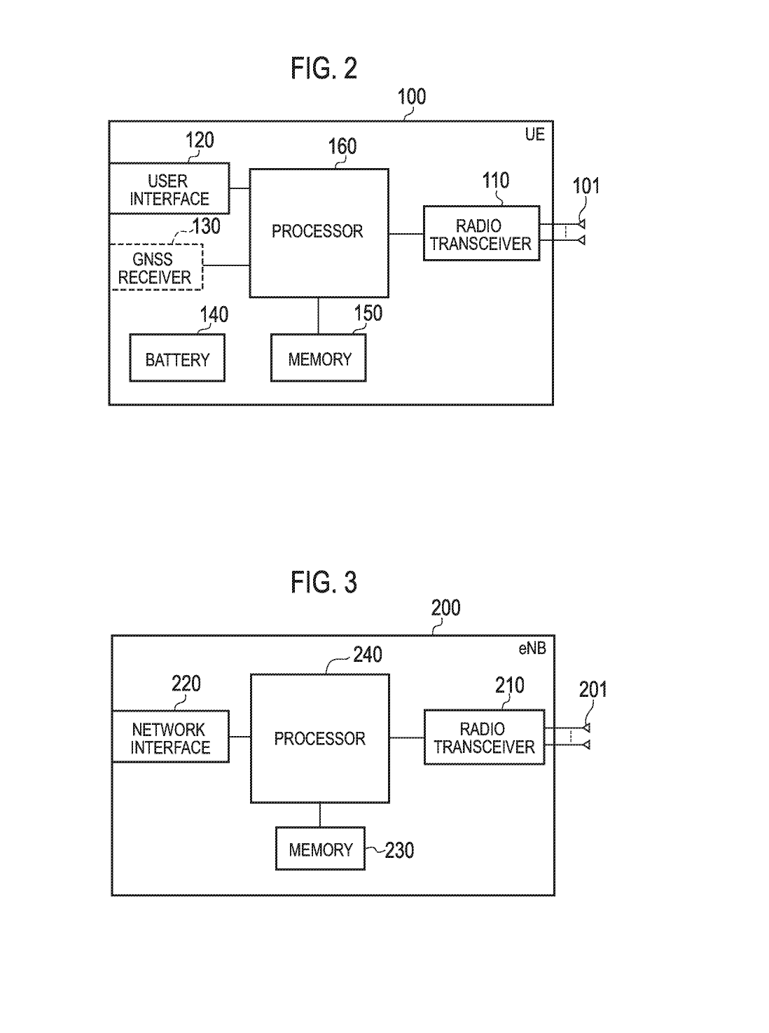

FIG. 2 is a block diagram of the UE 100. As shown in FIG. 2, the UE 100 includes a plurality of antennas 101, a radio transceiver 110, a user interface 120, GNSS (Global Navigation Satellite System) receiver 130, a battery 140, a memory 150, and a processor 160. The memory 150 and the processor 160 configure a control unit. The radio transceiver 110 and the processor 160 configure a transmission unit and a reception unit. The UE 100 may not have the GNSS receiver 130. Furthermore, the memory 150 may be integrally formed with the processor 160, and this set (that is, a chip set) may be called a processor.

The antennas 101 and the radio transceiver 110 are used to transmit and receive a radio signal. The radio transceiver 110 converts a baseband signal (transmission signal) output from the processor 160 into the radio signal, and transmits the radio signal from the antenna 101. Furthermore, the radio transceiver 110 converts the radio signal received by the antenna 101 into the baseband signal (reception signal), and outputs the baseband signal to the processor 160.

The user interface 120 is an interface with a user carrying the UE 100, and includes, for example, a display, a microphone, a speaker, various buttons and the like. The user interface 120 receives an operation from a user and outputs a signal indicating the content of the receiving operation to the processor 160. The GNSS receiver 130 receives a GNSS signal in order to obtain location information indicating a geographical location of the UE 100, and outputs the received signal to the processor 160. The battery 140 accumulates a power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and a CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As shown in FIG. 3, the eNB 200 includes a plurality of antennas 201, a radio transceiver 210, a network interface 220, a memory 230, and a processor 240. The memory 230 and the processor 240 constitute a control unit. The radio transceiver 210 (and/or the network interface 220) and the processor 160 configure a transmission unit and a reception unit. In addition, the memory 230 is integrated with the processor 240, and this set (that is, a chipset) may be called a processor.

The antennas 201 and the radio transceiver 210 are used to transmit and receive a radio signal. The radio transceiver 210 converts the baseband signal (transmission signal) output from the processor 240 into the radio signal, and transmits the radio signal from the antenna 201. Furthermore, the radio transceiver 210 converts the radio signal received by the antenna 201 into the baseband signal, and outputs the baseband signal (reception signal) to the processor 240.

The network interface 220 is connected to the neighboring eNB 200 via the X2 interface and is connected to the MME/S-GW 300 via the Si interface. The network interface 220 is used in communication performed on the X2 interface and communication performed on the Si interface.

The memory 230 stores a program to be executed by the processor 240 and information to be used for a process by the processor 240. The processor 240 includes the baseband processor that performs modulation and demodulation, encoding and decoding and the like on the baseband signal and a CPU that performs various processes by executing the program stored in the memory 230. The processor 240 executes various processes and various communication protocols described later.

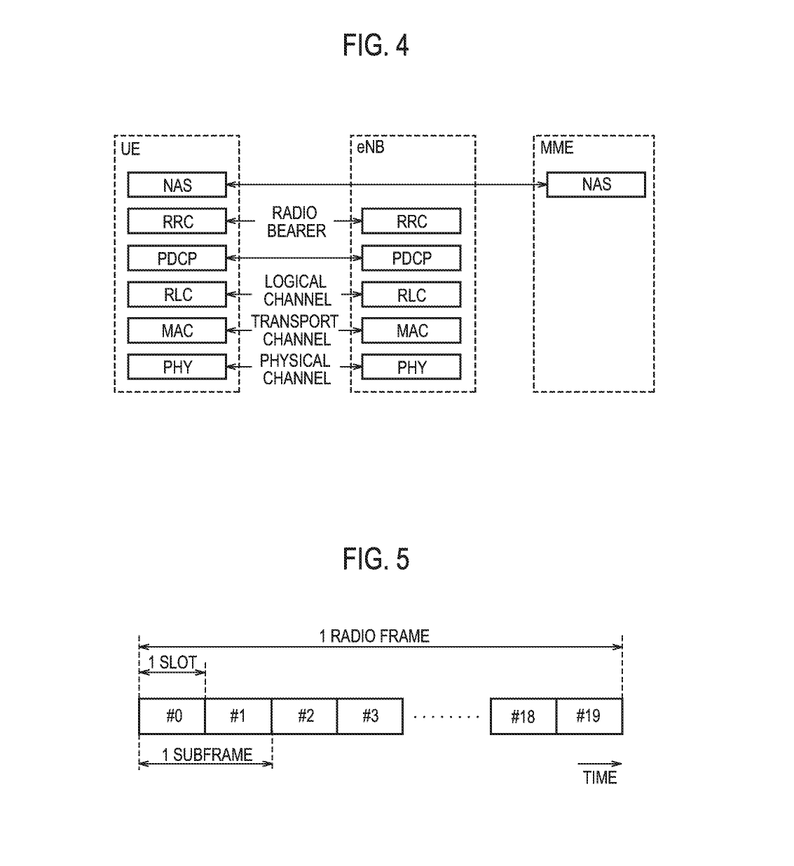

FIG. 4 is a protocol stack diagram of a radio interface in the LTE system. As shown in FIG. 4, the radio interface protocol is classified into a layer 1 to a layer 3 of an OSI reference model, wherein the layer 1 is a physical (PHY) layer. The layer 2 includes MAC (Medium Access Control) layer, RLC (Radio Link Control) layer, and PDCP (Packet Data Convergence Protocol) layer. The layer 3 includes RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, user data and control information are transmitted through the physical channel.

The MAC layer performs priority control of data, a retransmission process by hybrid ARQ (HARQ), a random access procedure, and the like. Between the MAC layer of the UE 100 and the MAC layer of the eNB 200, user data and control information are transmitted via a transport channel. The MAC layer of the eNB 200 includes a transport format of an uplink and a downlink (a transport block size, a modulation and coding scheme (MCS) and the like) and a MAC scheduler to decide a resource block to be assigned to UEs 100.

The RLC layer transmits data to an RLC layer of a reception side by using the functions of the MAC layer and the PHY layer. Between the RLC layer of the UE 100 and the RLC layer of the eNB 200, user data and control information are transmitted via a logical channel.

The PDCP layer performs header compression and decompression, and encryption and decryption.

The RRC layer is defined only in a control plane handling control information. Between the RRC layer of the UE 100 and the RRC layer of the eNB 200, control information (an RRC message) for various types of setting is transmitted. The RRC layer controls the logical channel, the transport channel, and the physical channel in response to establishment, re-establishment, and release of a radio bearer. When there is a connection (an RRC connection) between the RRC of the UE 100 and the RRC of the eNB 200, the UE 100 is in a RRC connected state, and when there is not a connection (the RRC connection) between the RRC of the UE 100 and the RRC of the eNB 200, the UE 100 is in an RRC idle state.

NAS (Non-Access Stratum) layer positioned above the RRC layer performs session management, mobility management and the like.

FIG. 5 is a configuration diagram of a radio frame used in the LTE system. In the LTE system, OFDMA (Orthogonal Frequency Division Multiplexing Access) is employed in a downlink, and SC-FDMA (Single Carrier Frequency Division Multiple Access) is employed in an uplink, respectively.

As shown in FIG. 5, the radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each resource block includes a plurality of subcarriers in a frequency direction. A resource element (RE) is configured by one symbol and one subcarrier. Further, of the radio resources (time-frequency resources) assigned to the UE 100, it is possible to identify a frequency resource by a resource block and identify a time resource by a subframe (or a slot).

(2) D2D Proximity Service

A D2D proximity service will be described, below. An LTE system according to a first embodiment supports the D2D proximity service.

The D2D proximity service is a service in which direct UE-to-UE communication is enabled. The D2D proximity service includes a discovery procedure (Discovery) in which a proximal UE is discovered and D2D communication (Communication) that is direct UE-to-UE communication. The D2D communication is also called Direct communication.

A scenario in which all UEs 100 forming asynchronization cluster are located inside a coverage of at least one cell is called “In coverage”. A scenario in which all the UEs 100 forming the synchronization cluster are located outside a coverage of at least one cell is called “Out of coverage”. A scenario in which some UEs 100, out of a plurality of UEs 100 forming the synchronization cluster, are located inside a coverage of at least one cell and the remaining UEs 100 are located outside a coverage of at least one cell is called “Partial coverage”.

In a case of the In coverage, the eNB 200 acts as a D2D synchronization source. A D2D asynchronization source, from which a D2D synchronization signal is not transmitted, is synchronized with the D2D synchronization source. The eNB 200 that is a D2D synchronization source broadcasts a broadcast signal including D2D resource information indicating a radio resource (resource pool) available for the D2D proximity service. The D2D resource information includes information indicating a resource pool for the discovery procedure (Discovery resource information) and information indicating a resource pool for the D2D communication (Communication resource information), for example. The UE 100 that is a D2D asynchronization source performs the discovery procedure and the D2D communication on the basis of the D2D resource information received from the eNB 200.

In a case of the Out of coverage or the Partial coverage, the UE 100 acts as a D2D synchronization source. In a case of the Out of coverage, the UE 100 that is a D2D synchronization source transmits D2D resource information indicating a radio resource (resource pool) available for the D2D proximity service. The D2D resource information is included in a D2D synchronization signal, for example. The D2D synchronization signal is a signal transmitted in the synchronization procedure in which a Device-to-Device synchronization is established. The D2D synchronization signal includes a D2D SS and a physical D2D synchronization channel (PD2DSCH). The D2D SS is a signal for providing a synchronization standard of a time and a frequency. The PD2DSCH is a physical channel through which a greater amount of information is carried than the D2D SS. The PD2DSCH carries the above-described D2D resource information (the Discovery resource information and the Communication resource information). Alternatively, when the D2D SS is previously associated with the D2D resource information, the transmission of the PD2DSCH may be omitted.

The discovery procedure is used mainly when the D2D communication is performed by unicast. In a case where a first UE 100 starts D2D communication with a second UE 100, the first UE 100 uses any radio resource out of the resource pool for the discovery procedure to transmit the Discovery signal. On the other hand, in a case where the second UE 100 starts the D2D communication with the first UE 100, the second UE 100 scans the Discovery signal within the resource pool for the discovery procedure to receive the Discovery signal. The Discovery signal may include information indicating a radio resource used by the first UE 100 for the D2D communication.

Further, a discovery procedure in which a user terminal that exists in the first cell discovers the proximal terminal that exists in a second cell provided around the first cell is called an inter-cell discovery procedure (Inter-Cell Discovery). D2D communication in which a user terminal that exists in the first cell performs communication with the proximal terminal that exists in the second cell is called inter-cell D2D communication (Inter-Cell Communication).

In the first embodiment, a detailed description is given regarding a D2D proximity service between the UE 100 that exists in the first cell and the UE 100 that exists in the second cell in an environment where no synchronization is established between the first cell and the second cell. Such a D2D proximity service is an example of the Partial Coverage.

(3) Operation Environment

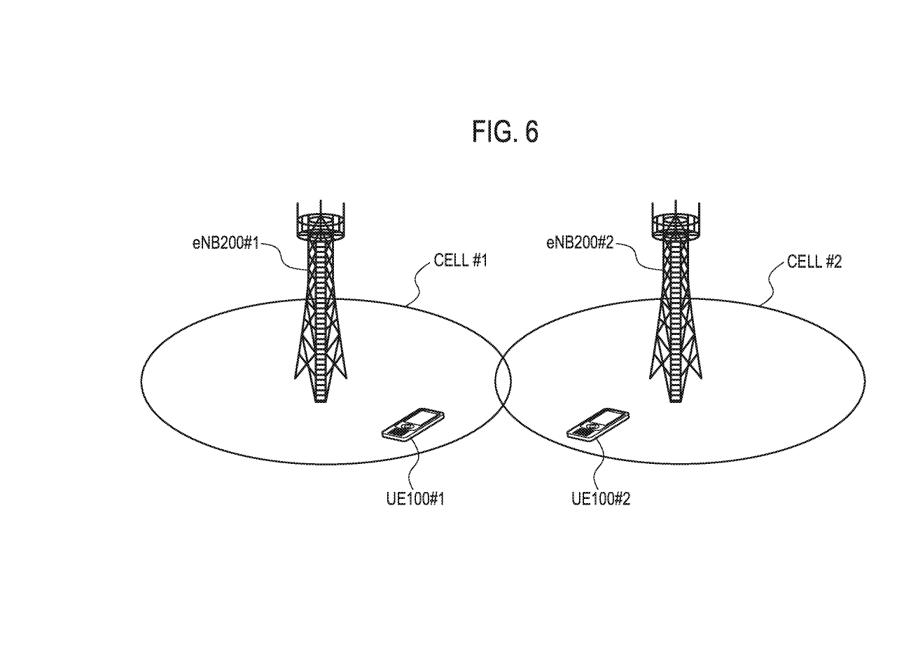

An operation environment according to the first embodiment will be described, below. FIG. 6 is a diagram showing an operation environment according to the first embodiment.

As shown in FIG. 6, the D2D proximity service is provided between a UE 100 #1 that exists in a cell #1 and a UE 100 #2 that exists in a cell #2.

The UE 100 #1 exists in the cell #1. The UE 100 #1 is in an RRC connected state or an RRC idle state in the cell #1. When the UE 100 #1 is focused, the cell #1 is an existing cell (a Camp on Cell) and the cell #2 is a neighboring cell. It is noted that when the UE 100 #1 is in an RRC connected state, the cell #1 is a serving cell.

The UE 100 #2 exists in the cell #2. The UE 100 #2 is in an RRC connected state or an RRC idle state in the cell #2. When the UE 100 #2 is focused, the cell #1 is a neighboring cell and the cell #2 is an existing cell (a Camp on Cell). It is noted that when the UE 100 #2 is in an RRC connected state, the cell #2 is a serving cell.

An eNB 200 #1 manages the cell #1, and an eNB 200 #2 manages the cell #2 with which no synchronization is established with the cell #1. The cell #1 and the cell #2 may be an Inter-Cell having a respectively different coverage, may be an Inter-Frequency-Cell operated by a respectively different frequency, and may be an Inter-PLMN-Cell that belongs to a respectively different PLMN (Public Land Mobile Network).

In such a precondition, the UE 100 #1 that exists in on the cell #1 (for example, the above-described processor 160) measures a timing difference (Timing Offset) between a timing of a signal received from the cell #1 and a timing of a signal received from the cell #2. Further, the UE 100 #1 that exists in the cell #1 (for example, the above-described radio transceiver 110) notifies the eNB 200 #1 that manages the cell #1, of the timing difference.

It is noted that a method, by the UE 100 #1, of measuring the timing difference may include (a) to (d) as follows:

(a) The UE 100 #1, while retaining the synchronization information (System Frame Number, Subframe Number, Slot Number, Symbol Number, etc.) of the cell #1, uses the synchronization-reference signal (PSS, SSS, CRS) of the cell #2 to synchronize with the cell #2. The UE 100 #1 uses the broadcast information (MIB) of the cell #2 to receive time information (System Frame Number, Subframe Number, Slot Number, Symbol Number, etc.) of the cell #2. The UE 100 #1 compares the synchronization information of the cell #1 and the time information of the cell #2 to measure the timing difference.

(b) The UE 100 #1 uses the synchronization-reference signal (PD2DSS, PD2DSCH, DM-RS) received from the D2D terminal (for example, the UE 100 #2 that exists in the cell #2) to be measured so as to synchronize with the UE 100 #2. Thereby, the UE 100 #1 is capable of artificially measuring a timing difference between a timing of a signal received from the cell #1 and a timing of a signal received from the cell #2.

(c) The UE 100 #1 compares the synchronization information of the cell #1 and the time information of the cell #2 to measure the timing difference, by way of UTC (Coordinated Universal Time) broadcast from the cell #1 or the cell #2. Specifically, a difference between UTC of a reference timing (for example, a specific System Frame Number, Subframe Number, Slot Number, Symbol Number, etc.) of the cell #1, and UTC of a reference timing (for example, a specific System Frame Number, Subframe Number, Slot Number, Symbol Number, etc.) of the cell #2 is measured as the timing difference. The UTC is included in an SIB16 broadcast from the cell #1 and the cell #2, for example.

(d) The UE 100 #1 compares the synchronization information of the cell #1 and the time information of the cell #2 to measure the timing difference, by way of the UTC held by the UE 100 #1. Specifically, a difference between UTC of a reference timing (for example, a specific System Frame Number, Subframe Number, Slot Number, Symbol Number, etc.) of the cell #1, and UTC of a reference timing (for example, a specific System Frame Number, Subframe Number, Slot Number, Symbol Number, etc.) of the cell #2 is measured as the timing difference. The UTC is included in a GNSS signal.

Here, the accuracy of the timing difference is not particularly limited; it is preferable that the accuracy is at least more than a Subframe Number level.

Further, the timing difference may be expressed in a relative value, and may be expressed in an absolute value. For example, a case is considered where in a measurement timing, the Subframe Number of the cell #1 is n and the Subframe Number of the cell #2 is m, and in a notification timing, the Subframe Number of the cell #1 is n+a. When the timing difference is expressed in a relative value, the timing difference is m−n. On the other hand, when the timing difference is expressed in an absolute value, the timing difference is m+a.

In the first embodiment, a method of measuring and notifying the timing difference may include three options as follows:

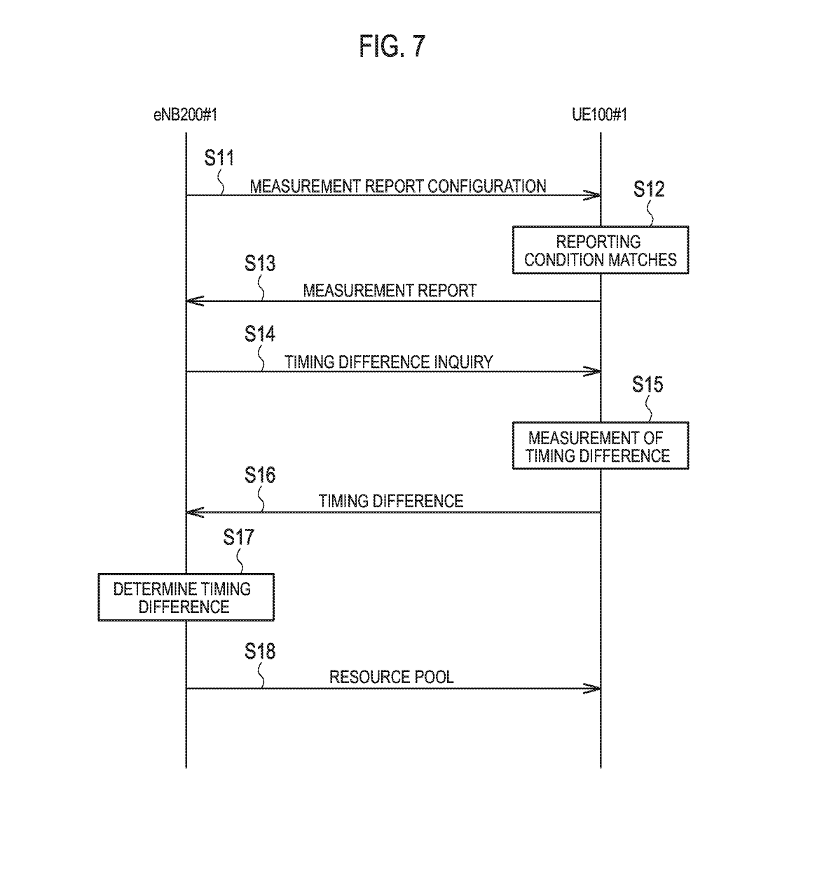

In a first option, the UE 100 #1 in an RRC connected state in the cell #1 measures and notifies the timing difference in real time responding to an explicit request of the eNB 200 #1. Specifically, the UE 100 #1 in an RRC connected state in the cell #1 executes measurement of the timing difference and notification of the timing difference in response to a timing difference inquiry received from the eNB 200 #1 that manages the cell #1. The first option will be described in detail later (see FIG. 7).

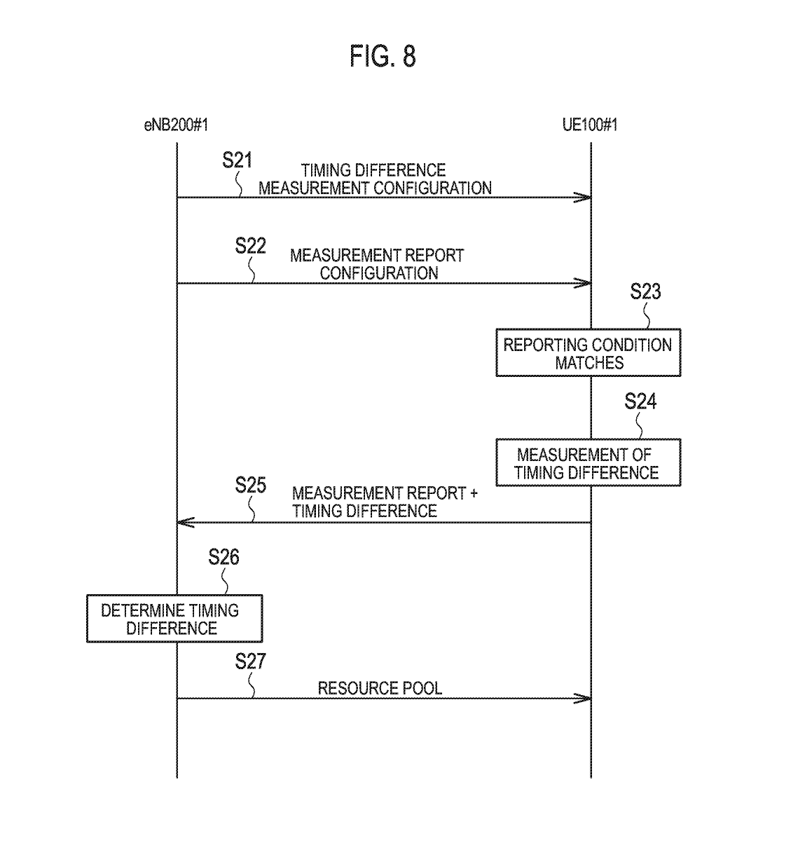

In a second option, the UE 100 #1 in an RRC connected state in the cell #1 autonomously measures and notifies the timing difference. Specifically, the UE 100 #1 in an RRC connected state in the cell #1 executes measurement of the timing difference and notification of the timing difference when a condition configured by the eNB 200 #1 that manages the cell #1 is satisfied. The first option will be described in detail later (see FIG. 8).

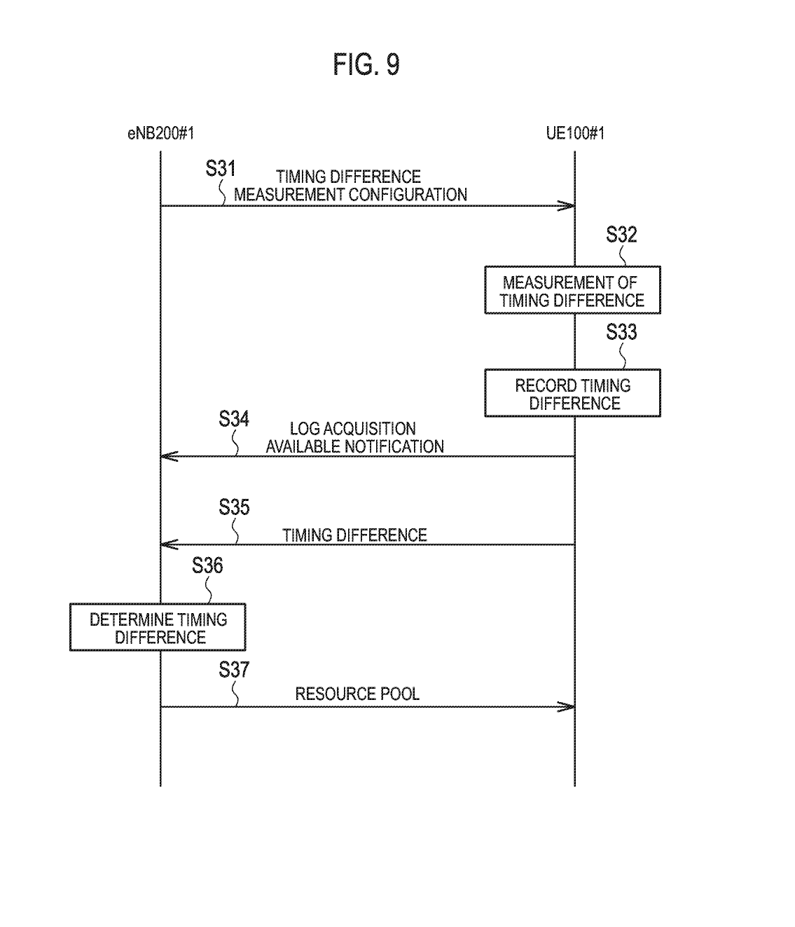

In a third option, the UE 100 #1 in an RRC idle state in the cell #1 autonomously measures the timing difference. Specifically, the UE 100 #1 in an RRC idle state in the cell #1 executes measurement of the timing difference when a condition configured by the eNB 200 #1 that manages the cell #1 is satisfied. Further, the UE 100 #1 in an RRC connected state in the cell #1 executes notification of the timing difference when transition from the RRC idle state to the RRC connected state in the cell #1. The third option will be described in detail later (see FIG. 9).

On the other hand, the eNB 200 #1 (for example, the above-described radio transceiver 210) receives a timing difference between a timing of a signal received from the cell #1 and a timing of a signal received from the cell #2, from a plurality of UEs 100 #1 that exists in the cell #1. The eNB 200 #1 (for example, the processor 240) determines a single timing difference used in the D2D proximity service on the basis of the timing difference received from the plurality of UEs 100 #1 that exists in the cell #1. The eNB 200 #1 (for example, the above-described radio transceiver 210) notifies the plurality of user terminals that exists in the cell #1 of a single timing difference.

Here, it is preferable that the eNB 200 #1 determines the single timing difference used in the D2D proximity service by a statistical process on a plurality of timing differences received from each of the plurality of UEs 100 #1. The statistical process includes a process of calculating an average value of a plurality of timing differences, a process of calculating a median of a plurality of timing differences, and a process of calculating a mode of a plurality of timing differences. It is noted that, needless to say, when the timing difference is concerned, an identical cell (here, the cell #2) is a subject to measurement.

Further, the eNB 200 #1 may directly notify the plurality of UEs 100 #1 of the single timing difference by broadcasting, together with the resource pool information (the above-described Discovery resource information or Communication resource information) used in the cell #1, the single timing difference. Alternatively, the eNB 200 #1 may shift the resource pool information used in the cell #1 in accordance with the single timing difference to thereby calculate the shifted resource pool information, and broadcast the shifted resource pool information to thereby indirectly notify the plurality of UEs 100 #1 of the single timing difference.

(4) Operation According to First Embodiment

An operation according to the first embodiment will be described, below. The above-described first option to the third option will be described, below.

(4.1) First Option

FIG. 7 is a sequence diagram showing the first option according to the first embodiment. It should be noted that in FIG. 7, the operation environment shown in FIG. 6 is a prerequisite.

As shown in FIG. 7, in step S11, the eNB 200 #1 transmits a measurement report configuration to the UE 100 #1. The measurement report configuration includes identification information of a target cell subject to a measurement report (Meas. Object), a reporting condition for performing a measurement report (Reporting. Config), and identification information by which the above are associated (Meas. ID).

In step S12, the UE 100 #1 detects that the reporting condition being satisfied. It should be noted here that the measurement report is information used for cell reselection or handover, and thus, when the reporting condition matches, it means that the UE 100 #1 is positioned at the end of the cell #1.

In step S13, the UE 100 #1 transmits the measurement report to the eNB 200 #1.

In step S14, the eNB 200 #1 transmits the timing difference inquiry to the UE 100 #1. The timing difference inquiry includes information for designating a cell in which the timing difference is to be measured (that is, a cell ID of the cell #2, a frequency ID to which the cell #2 belongs, an ID of PLMN to which the cell #2 belongs, etc.). Alternatively, the timing difference inquiry may include information for designating a D2D terminal to be measured when the timing difference is measured on the basis of a signal received from the D2D terminal to be measured.

In step S15, the UE 100 #1 measures a timing difference between a timing of a signal received from the cell #1 and a timing of a signal received from the cell #2.

In step S16, the UE 100 #1 notifies the eNB 200 #1 of the timing difference. The timing difference includes information for designating a cell in which the timing difference is to be measured (that is, a cell ID of the cell #2, a frequency ID to which the cell #2 belongs, an ID of PLMN to which the cell #2 belongs, etc.). Alternatively, the timing difference may include information for designating the D2D terminal to be measured when the timing difference is measured on the basis of a signal received from the D2D terminal to be measured.

In step S17, the eNB 200 #1 determines a single timing difference used in the D2D proximity service between the UE 100 #1 that exists in the cell #1 and the UE 100 #2 that exists in the cell #2, on the basis of the timing difference received from the UE 100 #1.

Here, when receiving the timing difference from a plurality of UEs 100 #1, the eNB 200 #1 determines the single timing difference by a statistical process on a plurality of timing differences.

In step S18, the eNB 200 #1 notifies the UE 100 #1 of the single timing difference. Here, the eNB 200 #1 may broadcast the single timing difference, together with the resource pool information used in the cell #1, to thereby directly notify the plurality of UEs 100 #1 of the single timing difference. Alternatively, the eNB 200 #1 may broadcast the shifted resource pool information to thereby indirectly notify the plurality of UEs 100 #1 of the single timing difference.

(4.2) Second Option

FIG. 8 is a sequence diagram showing the second option according to the first embodiment. It should be noted that in FIG. 8, the operation environment shown in FIG. 6 is a prerequisite.

As shown in FIG. 8, in step S21, the eNB 200 #1 transmits a timing difference measurement configuration to the UE 100 #1. The timing difference measurement configuration includes information for designating a cell in which the timing difference is to be measured (that is, a cell ID of the cell #2, a frequency ID to which the cell #2 belongs, an ID of PLMN to which the cell #2 belongs, etc.). Alternatively, the timing difference measurement configuration may include information for designating the D2D terminal to be measured when the timing difference is measured on the basis of a signal received from the D2D terminal to be measured. A measurement condition to measure the timing difference is similar to the reporting condition (Reporting. Config) included in the measurement report configuration transmitted in step S22.

It is noted that the timing difference measurement configuration may include a measurement condition to measure the timing difference, in addition to information for designating a cell in which the timing difference is to be measured. In such a case, the measurement condition may be similar to the reporting condition (Reporting. Config), and may be different from the reporting condition (Reporting. Config). The measurement condition preferably is a condition to express that the UE 100 #1 is positioned at the end of the cell #1.

In step S22, the eNB 200 #1 transmits the measurement report configuration to the UE 100 #1. The measurement report configuration includes identification information of a target cell subject to a measurement report (Meas. Object), a reporting condition for performing a measurement report (Reporting. Config), and identification information by which the above are associated (Meas. ID).

In step S23, the UE 100 #1 detects that the reporting condition being satisfied. It should be noted here that the measurement report is information used for cell reselection or handover, and thus, when the reporting condition matches, it means that the UE 100 #1 is positioned at the end of the cell #1.

In step S24, the UE 100 #1 measures a timing difference between a timing of a signal received from the cell #1 and a timing of a signal received from the cell #2.

In step S25, the UE 100 #1 transmits the measurement report and the timing difference to the eNB 200 #1. The timing difference includes information for designating a cell in which the timing difference is to be measured (that is, a cell ID of the cell #2, a frequency ID to which the cell #2 belongs, an ID of PLMN to which the cell #2 belongs, etc.). Alternatively, the timing difference may include information for designating the D2D terminal to be measured when the timing difference is measured on the basis of a signal received from the D2D terminal to be measured.

In step S26, the eNB 200 #1 determines a single timing difference used in the D2D proximity service between the UE 100 #1 that exists in the cell #1 and the UE 100 #2 that exists in the cell #2, on the basis of the timing difference received from the UE 100 #1.

Here, when receiving the timing difference from a plurality of UEs 100 #1, the eNB 200 #1 determines the single timing difference by a statistical process on a plurality of timing differences.

In step S27, the eNB 200 #1 notifies the UE 100 #1 of the single timing difference. Here, the eNB 200 #1 may broadcast the single timing difference, together with the resource pool information used in the cell #1, to thereby directly notify the plurality of UEs 100 #1 of the single timing difference. Alternatively, the eNB 200 #1 may broadcast the shifted resource pool information to thereby indirectly notify the plurality of UEs 100 #1 of the single timing difference.

(4.3) Third Option

FIG. 9 is a sequence diagram showing the second option according to the first embodiment. It should be noted that in FIG. 9, the operation environment shown in FIG. 6 is a prerequisite.

As shown in FIG. 9, in step S31, the eNB 200 #1 transmits a timing difference measurement configuration to the UE 100 #1. The timing difference measurement configuration includes information for designating a cell in which the timing difference is to be measured (that is, a cell ID of the cell #2, a frequency ID to which the cell #2 belongs, an ID of PLMN to which the cell #2 belongs, etc.), and a measurement condition to measure the timing difference. Alternatively, the timing difference measurement configuration may include information for designating the D2D terminal to be measured when the timing difference is measured on the basis of a signal received from the D2D terminal to be measured. Here, the measurement condition preferably is a condition to express that the UE 100 #1 is positioned at the end of the cell #1.

In step S32, the UE 100 #1 detects the measurement condition being satisfied, and measures a timing difference between a timing of a signal received from the cell #1 and a timing of a signal received from the cell #2.

In step S33, the UE 100 #1 records a timing difference between a timing of a signal received from the cell #1 and a timing of a signal received from the cell #2.

In step S34, the UE 100 #1 transitions from the RRC idle state to the RRC connected state in the cell #1, and transmits a log acquisition available notification to the eNB 200 #1. The log acquisition available notification is a notification that indicates that the UE 100 #1 records the timing difference already measured in the RRC idle state.

In step S35, the UE 100 #1 transmits a measurement report and a timing difference to the eNB 200 #1. The timing difference includes information for designating a cell in which the timing difference is to be measured (that is, a cell ID of the cell #2, a frequency ID to which the cell #2 belongs, an ID of PLMN to which the cell #2 belongs, etc.). Alternatively, the timing difference may include information for designating the D2D terminal to be measured when the timing difference is measured on the basis of a signal received from the D2D terminal to be measured.

In step S36, the eNB 200 #1 determines a single timing difference used in the D2D proximity service between the UE 100 #1 that exists in the cell #1 and the UE 100 #2 that exists in the cell #2, on the basis of the timing difference received from the UE 100 #1.

Here, when receiving the timing difference from a plurality of UEs 100 #1, the eNB 200 #1 determines the single timing difference by a statistical process on a plurality of timing differences.

In step S37, the eNB 200 #1 notifies the UE 100 #1 of the single timing difference. Here, the eNB 200 #1 may broadcast the single timing difference, together with the resource pool information used in the cell #1, to thereby directly notify the plurality of UEs 100 #1 of the single timing difference. Alternatively, the eNB 200 #1 may broadcast the shifted resource pool information to thereby indirectly notify the plurality of UEs 100 #1 of the single timing difference.

(5) Operation and Effect

In the first embodiment, from the UE 100 #1 that exists in the cell #1 to the eNB 200 #1 that manages the cell #1, the timing difference between a timing of a signal received from the cell #1 and a timing of a signal received from the cell #2 is notified. As a result, even in an environment where no synchronization is established between the cell #1 and the cell #2, it is possible to perform a D2D proximity service between the UE 100 #1 that exists in the cell #1 and the UE 100 #2 that exists in the cell #2.

In the first embodiment, the eNB 200 #1 that manages the cell #1 determines, on the basis of a plurality of timing differences notified from a plurality of UEs 100 #1 that exists in the cell #1, a single timing difference used for the D2D proximity service, and notifies the plurality of UEs 100 #1 that exists in the cell #1 of a single timing difference. Thus, it is possible to determine a single timing difference acceptable by many UEs 100 #1 that exists in the cell #1. Further, even in an environment where no synchronization is established between the cell #1 and the cell #2, it is possible to perform a D2D proximity service between the UE 100 #1 that exists in the cell #1 and the UE 100 #2 that exists in the cell #2.

[First Modification]

A first modification of the first embodiment will be described, below. Description proceeds with a particular focus on a difference from the first embodiment, below.

In the first embodiment, the UE 100 #1 that exists in the cell #1 measures the timing difference. On the other hand, in a first modification, the eNB 200 #1 that manages the cell #1 calculates the timing difference.

Specifically, the eNB 200 #1 (for example, the above-described network interface 220) receives the timing information indicating a timing of a signal transmitted from the cell #2, from the eNB 200 #2 that manages the cell #2. The eNB 200 #1 (for example, the above-described processor 240) determines the timing difference used in the D2D proximity service on the basis of the timing information.

The timing information is time information (System Frame Number, Subframe Number, Slot Number, Symbol Number, etc.) of the cell #2, for example. The timing information may include, in addition to these pieces of information, UTC (Coordinated Universal Time) on which the eNB 200 #2 acquires the time information of the cell #2.

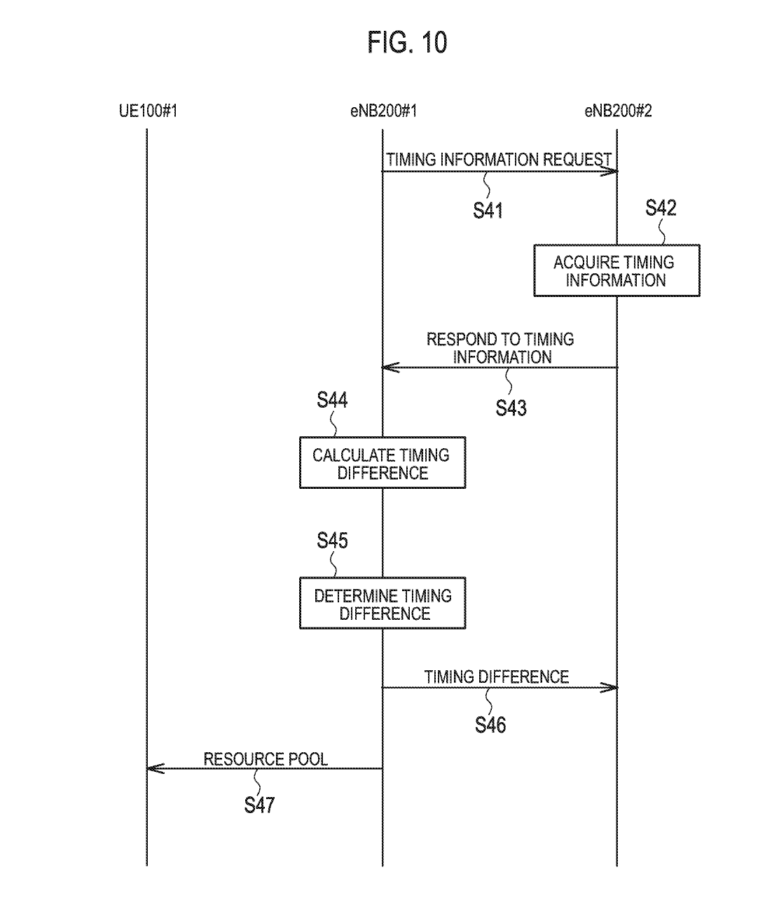

In particular, as shown in FIG. 10, in step S41, the eNB 200 #1 that manages the cell #1 transmits the timing information request to the eNB 200 #2 that manages the cell #2.

In step S42, the eNB 200 #2 acquires the timing information.

In step S43, the eNB 200-2 transmits the timing information to the eNB 200 #1.

In step S44, the eNB 200 #1 calculates a timing difference between a timing of a signal received from the cell #1 and a timing of a signal received from the cell #2, on the basis of the timing information.

In step S45, the eNB 200 #1 determines a single timing difference used in the D2D proximity service between the UE 100 #1 that exists in the cell #1 and the UE 100 #2 that exists in the cell #2, on the basis of the timing difference calculated in step S44.

In step S46, the eNB 200 #1 notifies the eNB 200 #2 of the single timing difference. The eNB 200 #2 preferably notifies the UE 100 #2 that exists in the cell #2 of the single timing difference. As a result, when the UE 100 #2 is a D2D synchronization source, it is possible to perform a D2D proximity service between the UE 100 #1 that exists in the cell #1 and the UE 100 #2 that exists in the cell #2.

It is noted that in much the same way as in the notification of the single timing difference from the eNB 200 #1 to the UE 100 #2, the eNB 200 #2 may broadcast the single timing difference, together with the resource pool information used in the cell #2, to thereby directly notify the UE 100 #2 of the single timing difference. Alternatively, the eNB 200 #2 may broadcast the shifted resource pool information to thereby indirectly notify the plurality of UEs 100 #2 of the single timing difference.

In step S47, the eNB 200 #1 notifies the UE 100 #1 of the single timing difference. Here, the eNB 200 #1 may broadcast the single timing difference, together with the resource pool information used in the cell #1, to thereby directly notify the plurality of UEs 100 #1 of the single timing difference. Alternatively, the eNB 200 #1 may broadcast the shifted resource pool information to thereby indirectly notify the plurality of UEs 100 #1 of the single timing difference.

### Other Embodiments

Contents of the present application are explained through the above-described embodiments, but it must not be understood that the contents of the present application are limited by the statements and the drawings constituting a part of this disclosure. From this disclosure, various alternative embodiments, examples, and operational technologies will become apparent to those skilled in the art.

Although not particularly described in the embodiment, when an expiration period of the already acquired timing difference is terminated in the first option, the eNB 200 #1 may transmit the timing difference inquiry to the UE 100 #1.

Although not particularly described in the embodiment, in the second option or the third option, the timing difference measurement configuration may be included in the SIB broadcast from the eNB 200 #1. In such a case, the timing difference measurement configuration may include the identification information of the UE 100 in which the timing difference is to be measured.

Although not particularly described in the embodiment, in the first option or the second option, the measurement report configuration may include the identification information of the UE 100 in which the timing difference is to be measured.

Although not particularly described in the embodiment, in the second option, the timing difference measurement configuration and the measurement report configuration may be an identical message. For example, the measurement report configuration may include information for designating a cell in which the timing difference is to be measured (that is, a cell ID of the cell #2, a frequency ID to which the cell #2 belongs, an ID of PLMN to which the cell #2 belongs, etc.). Alternatively, the measurement report configuration may include information for designating the D2D terminal to be measured when the timing difference is measured on the basis of a signal received from the D2D terminal to be measured. Further, the measurement report configuration may include the identification information of the UE 100 in which the timing difference is to be measured.

Although not particularly described in the embodiment, in the third option, the eNB 200 #1 may notify the UE 100 #1 of an indication that the timing difference should be measured only when the UE 100 #1 is in an RRC idle state in the cell #1.

Although not particularly described in the embodiment, in the third option, the timing difference measurement configuration may include a grace period from receiving the timing difference measurement configuration until the timing difference is measured. The UE 100 #1 measures the timing difference after a grace period elapses from receiving the timing difference configuration. The grace period may be expressed by for example, System Frame Number, Subframe Number, etc.

Although not particularly described in the embodiment, in the third option, the timing difference measurement configuration may be individually notified to the UE 100 #1 when the UE 100 #1 is in an RRC connected state. For example, the timing difference measurement configuration may be included in an RRC message. It should be noted that the measurement of the timing difference is performed when the UE 100 #1 is in an RRC idle state.

Although not particularly described in the embodiment, in the third option, the timing difference measurement configuration may include information indicating a predetermined period from measuring or recording the timing difference until attempting to notify the eNB 200 #1 of the timing difference. The UE 100 #1 attempts to notify the eNB 200 #1 of the timing difference when a predetermined period passes from measuring or recording the timing difference.

Although not particularly described in the embodiment, in the third option, the UE 100 #1 may abandon the timing difference when a predetermined period passes from measuring or recording the timing difference.

Although not particularly described in the embodiment, the resource pool information and the single timing difference may be included in an SIB 18 broadcast from the eNB 200 #1. Likewise, the shifted resource pool information may be included in the SIB 18 broadcast from the eNB 200 #1.

Although not particularly described in the embodiment, it is preferable that the measurement of the timing difference is performed at a timing excluding a reception timing of a Paging signal, a measurement timing of reception quality, etc.

Although not particularly described in the embodiment, the timing difference notified from the UE 100 #1 to the eNB 200 #1 may include a type of channels to be used for measuring the timing difference. For example, when the timing difference is measured on the basis of a signal received from the cell #2, the type of channels is PSS/SSS, etc. On the other hand, when the timing difference is measured on the basis of a signal received from the D2D terminal to be measured, the type of channels is PD2DSS, etc.

Although not particularly mentioned in the embodiments, a program may be provided for causing a computer to execute each process performed by the UE 100 and the eNB 200. Furthermore, the program may be recorded on a computer-readable medium. By using the computer-readable medium, it is possible to install the program in a computer. Here, the computer-readable medium recording the program thereon may include a non-transitory recording medium. The non-transitory recording medium is not particularly limited. For example, the non-transitory recording medium may include a recording medium such as a CD-ROM or a DVD-ROM.

Alternatively, a chip may be provided which is configured by: a memory in which a program for performing each process performed by the UE 100 and the eNB 200 is stored; and a processor for executing the program stored in the memory.

In the embodiments, the LTE system is described as one example of a mobile communication system. However, the embodiments are not limited to it. A mobile communication system may be a system other than the LTE system.

[Additional Statement]

A supplementary matter of the embodiment is provided below.

(1) Introduction

The inter-frequency and intra-frequency neighbouring cell discovery are unclear. In this addition statement, the remaining issues are discussed and suggestions for clarifications are provided.

(2) Discussion

(2.1) Synchronous and Asynchronous Deployments

According to agreement to support both deployment scenarios, which are synchronized deployment and asynchronized deployment, for inter-cell discovery, UEs 100 (D2D UEs) should have the capability to support inter-cell discovery regardless in both synchronous and asynchronous deployment scenarios. Under the synchronous deployment scenario, the UE 100's timing with its serving cell may be used for intra/inter-frequency, inter-cell discovery. On the other hand, under the asynchronous deployment scenario, the ability for the UE 100 to perform inter-cell discovery will depend on whether the serving cell knows the neighbouring cell's timing information.

(Asynchronous Deployment Scenario with Timing Offset)

With knowledge of the neighbouring cell's timing information, the serving cell may provide implicit or explicit timing information of the neighbour cell to its UEs 100 (D2D UEs). This allows the UEs 100 to perform inter-cell discovery without the direct synchronization with the UEs 100 served by neighbouring cells. With implicit timing information, the timing information is not directly provided to the UE 100. Instead, the discovery reception pools from the neighbouring cells are pre-adjusted with the time difference between the serving and the neighbouring cells. As the name suggests, with explicit timing information, the timing information is directly provided to the UE 100 and the discovery reception resource provided by the cell is not pre-adjusted with the timing difference between cells. With regard to the UE complexity and the amount of data in SIB, implicit scheme seem to be preferable.

(Asynchronous Deployment Scenario without the Timing Offset)

If timing information of the neighbouring cell is not available to the serving cell, the UE 100 will need to synchronize directly with the neighbouring cell to perform the inter-cell discovery using one of the two alternatives below:

(a) Monitoring PSS/SSS and MIB transmitted from the neighbouring cells

(b) Monitoring D2DSS and PD2DSCH transmissions from UEs 100 (D2D UEs) in the neighbouring cells

The alternatives suggest that the synchronization scheme without timing offset information will differ significantly from the scenario with timing offset information. It should consider whether the complexities suggested by the alternatives are reasonable and whether the asynchronous deployment scenario without the timing offset should be supported for inter-cell discovery.
Proposal 1: It should discuss whether asynchronous deployment scenario without the timing offset should be supported for inter-cell discovery.

Currently, it is up to eNB implementation whether D2DSS is configured to be transmitted by UEs 100 (D2D UEs). Whether or not D2DSS is configured may also depend on regional requirements including public safety requirements of specific regions. Therefore, to allow more flexibility for operators, both timing offset sharing and D2DSS without timing offset sharing should be supported for inter-cell discovery in asynchronous deployments.

If the timing offset is available, reception of the discovery signal from neighbour UEs (D2D UEs) may be possible with either the implicit provisioning or the explicit provisioning as mentioned above without D2DSS. If timing offset is not available, it should also be possible for the monitoring UE 100 to decode D2DSS transmitted by the neighbouring cell UE in order to synchronize with the neighbouring cell's discovery resource.
Proposal 2: For inter-cell discovery under the asynchronous deployment scenario, the network should have the option to use either timing offset or D2DSS to allow the UE 100 to synchronize with discovery resources from the neighbouring cell.

(2.2) Discovery Resource Pool

With regards to the discovery reception pool for inter-cell discovery, the following agreement was reached.

The eNB may provide D2D reception discovery resources in SIB. These may cover resources used for D2D transmission in this cell as well as resources used in neighbour cells. Details are for further study.

This agreement would suggest the discovery reception resources are shared between the serving cell and the neighbouring cell. However, there is currently no agreement that the discovery reception resources have to be shared between the serving cell and the neighbouring cells. Therefore, in order to clarify the contents of the SIB, it should be discussed whether or not the inter-cell discovery can be performed if the serving cell does not know the reception discovery resource of the neighbouring cell.

In case inter-cell discovery is supported by the serving cell, but the discovery reception resources of the neighbouring cell is not available to the serving cell, the UE 100 will need to obtain discovery reception resources through other means. For example, the UE 100 may acquire the discovery reception resources directly from the neighbouring cell's SIB or from the PD2DSCH transmitted by other UEs 100 (D2D UEs) served by the neighbouring cell. However, it had agreed that UEs 100 are not required to decode the neighbouring cell's SIB and the structure of the PD2DSCH is under considering, so the direct acquisition scheme of the neighbouring cell's discovery reception resource should be precluded from Rel-12.

Observation 1: If the serving cell is provided with the neighbouring cell's discovery information, the UE 100 is not required to obtain the discovery information directly from the neighbouring cell's SIB or PD2DSCH.

Proposal 3: If the serving cell is not provided with the neighbouring cell's discovery information, it should also decide if inter-cell discovery can still be supported.

(2.3) Inter-Frequency Support

The following agreement was reached for inter-frequency neighbour cell support.

The serving cell may provide in SIB information which neighbour frequencies support ProSe discovery. What information is required for other deployments and how much data that will comprise (feasible for SIB?) are for further study.

This agreement means the UE 100 (D2D UE) can obtain the neighbour frequency list from its serving cell. This will allow the UE 100 to decode the SIB (i.e., SIB18) from neighbour cells for the frequency of interest. However, it may be necessary for the UE 100 (D2D UE) to perform inter-frequency SIB18 decoding frequently or at least at SIB modification boundaries in case the contents of SIB18 changes, every time the UE is interested in inter-frequency discovery. As a result, two alternatives for inter-frequency discovery support may be considered;

ALT 1: The UE 100 obtains the inter-frequency discovery reception information directly from the neighbour cell's SIB.

ALT 2: The UE 100 obtains the inter-frequency discovery reception information from its serving cell's SIB.

With ALT 1, it would still be necessary for the UE 100 to obtain the discovery reception information directly from the neighbour cell. With ALT 1, it will also need the serving cell to configure gaps for the UE 100 just to obtain the updated SIB18 from the inter-frequency neighbour cell. This adds significant complexities to the serving cell. With ALT 2, the UE 100 will be able to obtain updated inter-frequency discovery reception information without gaps. Therefore, ALT 2 should be supported, for inter-frequency discovery.

Proposal 4: The serving cell provides in SIB inter-frequency discovery reception information corresponding to each supported discovery frequency.

If the Proposal 4 is acceptable, the remaining issue is what information is required for the reception. The possible information is listed below, for each frequency.
Discovery reception pools
Physical layer parameters (e.g. MCS, CP length and so on)
   Synchronous/asynchronous deployment indicator and/or Timing offset information for asynchronous deployment (up to how to support asynchronous deployment as discussed in section 2.1): It may or may not intend to instruct transmitting PD2DSS.

(2.4) Inter-Cell Discovery Transmission & Reception

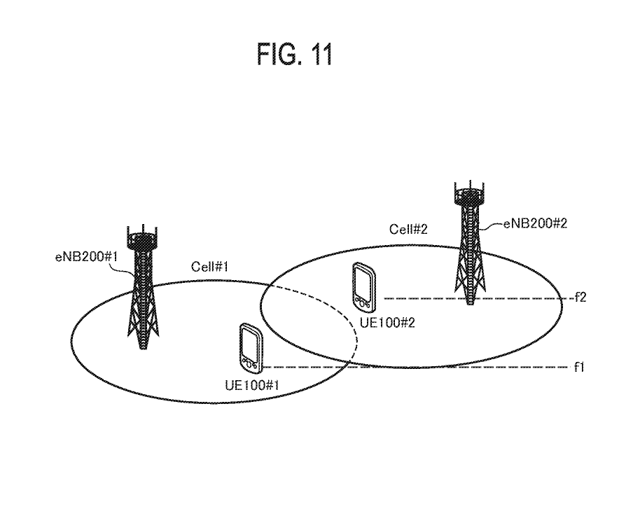

In addition to inter-frequency discovery reception, it is also necessary to consider how inter-frequency discovery transmissions should be handled. For the synchronous scenario, if the serving cell discovery resources fully-overlaps the inter-frequency inter-frequency, inter-cell discovery can be achieved for both D2D reception and transmissions without special considerations. However, if the inter-frequency cells are non-synchronous or if the discovery resources are not fully overlapping, further enhancements will be needed. The following alternatives may be considered (See FIG. 11). FIG. 11 is a diagram showing an example of the deployment scenario for inter-frequency.

ALT 1: UE 100#1 transmits the discovery signal on a frequency f1, and then UE 100#2 receives the signal on the frequency f1. In this Alt 1, the UE 100#2 is assumed to have at least a receiver for each of the two frequencies.

ALT 2: The UE 100#1 transmits the discovery signal on a frequency f2, and then the UE 100#2 receives the signal on the frequency f2. In this Alt 2, the UE 100#1 may be assumed to have at least a transmitter for both frequencies.

ALT 3: The UE 100#1 transmits the discovery signal on the frequency f1, and then the UE 100#2 receives the signal on the frequency f1 after it is handed over to the frequency f1. In this Alt 3, the eNB 200#2 operating Cell #2 is assumed to have another cell that can be operated on the frequency f1.

The ALT 1 is a straightforward scheme since Cell #1 allocates only the discovery resources for transmissions within its own operating frequency to the UE 100#1, while the UE 100#2 will need to receive the discovery signal on a frequency different from its serving frequency.

The ALT 2 has the potential for more flexibility in the network planning, assuming the multi-carrier D2D operation is supported. However, for the D2D Communication, it agreed that the While being in the coverage area of an E-UTRA cell, the UE 100 may only perform ProSe Direct Communication Transmission on the UL carrier of that cell only on the resources assigned by that cell, so this means the UE 100 (D2D UE) should only perform D2D discovery transmissions on the UL carrier of the cell where the discovery resource is assigned.

The ALT 3 is a mechanism to reuse the intra-frequency D2D discovery as much as possible under the multi-frequency deployment scenario. Due to the reuse of the existing intra-frequency D2D discovery mechanism, the Alt 3 may result with the least impact to the UE 100.

Based on the above understanding, UEs 100 should only transmit discovery signals based on the serving cell's discovery transmission resources. Therefore, the ALT2 should not be further considered.

Proposal 5: For inter-frequency discovery, the UE 100 (D2D UE) should not be allowed to transmit discovery signal on a frequency different from the serving cell's frequency as described in the ALT 2.

Proposal 6: The UE 100 should transmit discovery signal based on the serving cell's discovery transmission resources.

It is noted that the entire content of U.S. Provisional Application No. 62/034,640 (filed on Aug. 7, 2014) is incorporated in the specification of the present application by reference.

### INDUSTRIAL APPLICABILITY

As described above, the user terminal and the base station according to the embodiment are useful in the mobile communication field.

1. A user terminal configured to exist in a first cell in a mobile communication system that supports a D2D proximity service between the user terminal configured to exist in the first cell and a user terminal configured to exist in a second cell, comprising:
a controller configured to measure a timing difference between a timing of a signal received from the first cell and a timing of a signal received from the second cell; and
a transmitter configured to notify a base station configured to manage the first cell, of the timing difference.

2. The user terminal according to claim 1, wherein
the controller measures the timing difference in response to a timing difference inquiry received from the base station configured to manage the first cell, and
the transmitter notifies the base station of the timing difference in response to the timing difference inquiry received from the base station configured to manage the first cell.

3. The user terminal according to claim 1, wherein
the controller measures the timing difference when a condition configured by the base station configured to manage the first cell is satisfied, and
the transmitter notifies the base station of the timing difference when the condition configured by the base station configured to manage the first cell is satisfied.

4. The user terminal according to claim 1, wherein
the controller measures the timing difference when the user terminal is in an RRC idle state in the first cell and when a condition configured by the base station configured to manage the first cell is satisfied, and
the transmitter notifies the base station of the timing difference when a transition from the RRC idle state to an RRC connected state in the first cell executes.

5. A base station configured to manage a first cell in a mobile communication system that supports a D2D proximity service between a user terminal configured to exist in the first cell and a user terminal configured to exist in a second cell, comprising:
a receiver configured to receive, from a plurality of user terminals configured to exist in the first cell, a timing difference between a timing of a signal received from the first cell and a timing of a signal received from the second cell;
a controller configured to determine, on the basis of the timing difference received from the plurality of user terminals configured to exist in the first cell, a single timing difference used in the D2D proximity service; and
a transmitter configured to notify the plurality of user terminals configured to exist in the first cell, of the single timing difference.

6. A base station configured to manage a first cell in a mobile communication system that supports a D2D proximity service between a user terminal configured to exist in the first cell and a user terminal configured to exist in a second cell, comprising:
a receiver configured to receive, from a base station configured to manage the second cell, timing information indicating a timing of a signal transmitted from the second cell; and
a controller configured to determine, on the basis of the timing information, a timing difference used in the D2D proximity service.

7. The base station according to claim 6, wherein the controller notifies the base station configured to manage the second cell of the timing difference.

8. The base station according to claim 6, wherein the controller notifies the user terminal configured to exist in the first cell of the timing difference.
